(19) United States
(12) Patent Application Publication
(10) Pub. No.: US 2008/0124070 A1
(43) Pub. Date: May 29, 2008

(54) Camera using programmable aperture

(76) Inventors: Chia-kai Liang, Taipei (TW); Homer H. Chen, Taipei (TW); David Yeh, Taipei (TW); Hartmann Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/723,779

(22) Filed: Mar. 22, 2007

(30) Foreign Application Priority Data
Nov. 28, 2006 (TW) 95143956

(51) Int. Cl. G03B 17/00

(52) U.S. Cl. 396/435

(57) ABSTRACT

A camera using a programmable aperture is disclosed in which a programmable lens is disposed between a lens assembly and a sensor to properly transmit or block light rays reflected by a photographed object and incident to the lens assembly and then received by the sensor so as to obtain records of the incident light rays at different positions on the lens assembly. Moreover, complete light field data of the photographed object can be restored to facilitate subsequent image processing at any focal length.

### BACKGROUND OF THE INVENTION

1. Field of the Invention

The present invention relates to a camera and, more particularly, to a camera using a programmable aperture to perform highly concentrated capture of a light field by dynamically changing the aperture type and the light transmittance of the aperture.

2. Description of Related Art

A light field is a dense sampling of the 5-dimensional plenoptic function, which describes the radiance at every point in space in every direction. Since radiance doesn't change along a ray in empty space (e.g., outside the convex hull of an object), the dimensionality can be reduced by one, if an appropriate parameterization is found, that reflects this property. This so-called 2-plane parameterization fulfills this requirement. It represents a ray via its intersection points with two parallel planes. Since each of these points is characterized by two parameters in the plane, this results in a 4-dimensional function.

Over the past decade research about light field including its theory and analysis, how to capture the light field, how to compress the light field, and new applications of the light field have become popular.

Using a conventional camera to capture the 4-D data is very time-consuming as it is necessary to constantly move the camera or the object and rely on accurate calibration in order to acquire correct motion information. Therefore, some researchers have invented various new equipment to speed up the capturing of the light field.

Basically, the new equipment can be divided into two types. The first type makes use of several cameras to form a camera array. Although this method can obtain high-quality signals, the camera array is very bulky and thus cannot be used by general consumers.

The other type is called a plenoptic camera. As shown in FIG. 1, a plenoptic camera 20 makes use of a conventional camera, and places a microlens array 22 on the original focus plane and moves an original sensor array 24 backwards. In this manner, light ray information from different directions can be obtained. Using this equipment, the 4-D light field data can be obtained by taking a picture. This equipment, however, has a big drawback in that the original resolution of the camera will be sacrificed. For instance, if the original resolution of the camera is 2000×2000 and it is desired to record 16 (4×4) light rays from different directions, the image resolution will reduce to 500×500. Moreover, the cost of the microlens array is very high, and its calibration is also very difficult. Furthermore, after a microlens array is installed in the conventional camera, normal images that could originally be taken can no longer be taken, hence causing much inconvenience to users.

In order to conquer the above problems, the present invention provides a camera using a programmable aperture, which performs highly concentrated capture of a light field by dynamically changing the aperture type and the transmittance.

### SUMMARY OF THE INVENTION

An object of the present invention is to provide a camera using a programmable aperture to acquire light field data of a photographed object.

Another object of the present invention is to provide a camera using a programmable aperture, which combines a conventional camera and a programmable aperture to greatly reduce the high cost of existent cameras for capturing light field. The camera of the present invention can therefore be used by general consumers.

Yet another object of the present invention is to provide a camera using a programmable aperture, which not only can capture light field data of a photographed object, but can also be used as a common camera.

Still yet another object of the present invention is to provide a camera using a programmable aperture, which combines a conventional camera and a programmable aperture in order to preserve the original resolution of the camera.

To achieve the above objects, the present invention provides a camera using a programmable aperture, which comprises at least a lens assembly, a sensor, and a programmable aperture. The sensor is located behind the lens assembly and is used for capturing images via the lens assembly. The programmable aperture is located between the lens assembly and the sensor, and has a plurality of regions used for dynamically adjusting the shape of the aperture and the light transmittance of the lens assembly when taking a picture. Partial portions of the plurality of regions are opened or closed each time to let these partial regions selectively transmit or block light so as to obtain several different sets of images. These images can then be used to restore a complete light field.

To achieve the above objects, the present invention also provides a camera using a programmable aperture, which comprises at least a lens assembly, at least a sensor, an aperture, and a programmable light transmitting or blocking element. The sensor is located behind the lens assembly and is used for capturing images via the lens assembly. The aperture is located between the lens assembly and the sensor, and is used to control the light transmittance of the lens assembly when taking a picture. The programmable light transmitting or blocking element is used to adjust the shape of the aperture so as to divide the aperture into a plurality of regions. Partial portions of the plurality of regions are opened or closed each time to let this partial regions selectively transmit or block light so as to obtain several different sets of images. These images can then be used to restore a complete light field.

### BRIEF DESCRIPTION OF THE DRAWINGS

The various objects and advantages of the present invention will be more readily understood from the following detailed description when read in conjunction with the appended drawings, in which:

FIG. 1 is a diagram of a conventional plenoptic camera of the prior art;

FIG. 2 is a diagram of a camera using a programmable aperture according to an embodiment of the present invention;

FIG. 3 is a diagram showing how the programmable aperture transmits or blocks light according to an embodiment of the present invention;

FIG. 4 is a diagram showing how the programmable aperture transmits or blocks light according to an embodiment of the present invention;

FIG. 5(a) is a diagram of a patterned turntable according to an embodiment of the present invention; and

FIG. 5(b) is a diagram showing how the patterned turntable of FIG. 5(a) is arranged between a lens assembly and a sensor according to an embodiment of the present invention.

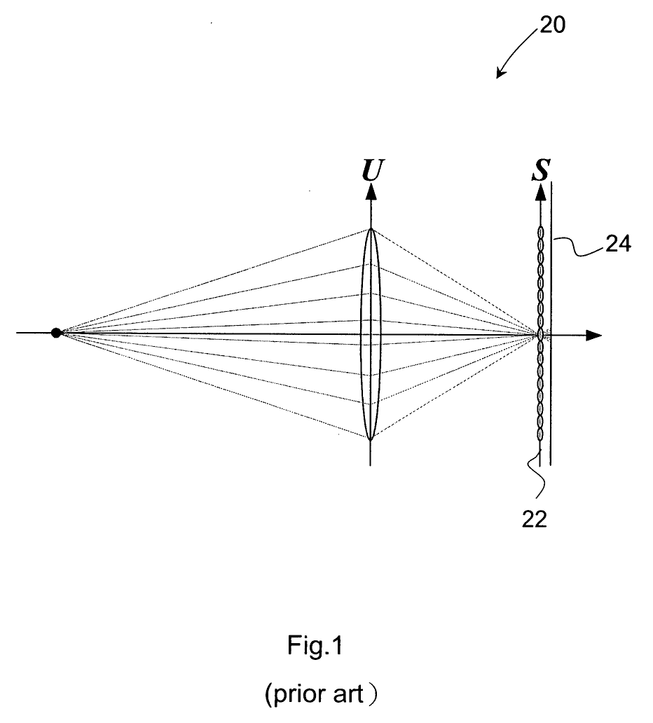

### DETAILED DESCRIPTION OF THE PREFERRED EMBODIMENTS

The present invention is characterized in that a programmable aperture is arranged between a lens assembly and a sensor to separately record light rays incident from different regions of the lens assembly so as to acquire complete light field data.

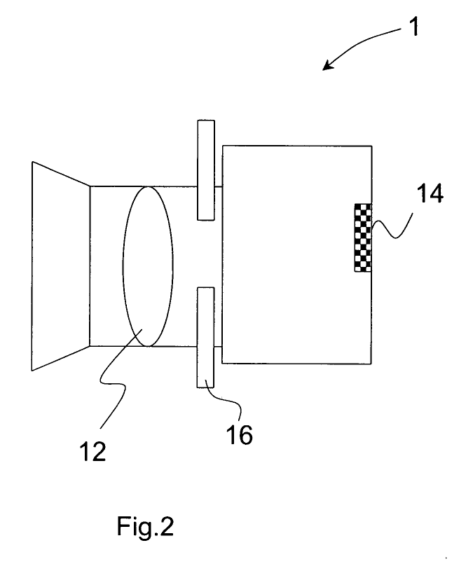

As shown in FIG. 2, a multi-aperture camera 1 of the present invention comprises a lens assembly 12, a sensor 14, and a programmable aperture 16. In an embodiment of the present invention the lens assembly 12 comprises a lens. The sensor 14 is located behind the lens assembly 12 and is used for capturing images via the lens assembly 12. The sensor 14 is composed of a sensor array. The programmable aperture 16 is located between the lens assembly 12 and the sensor 14, and is used to dynamically adjust the aperture shape and the incident positions of light rays through the lens assembly 12 when taking a picture.

Two embodiments of the programmable aperture 16 are illustrated below. It should be noted that many details can be modified to those of ordinary skill in the art (e.g., the selection of opened regions of the lens assembly 12 during the programming procedure). Therefore, all such substitutions and modifications are intended to be embraced within the scope of the invention. It will be understood that the invention is not limited to the details thereof.

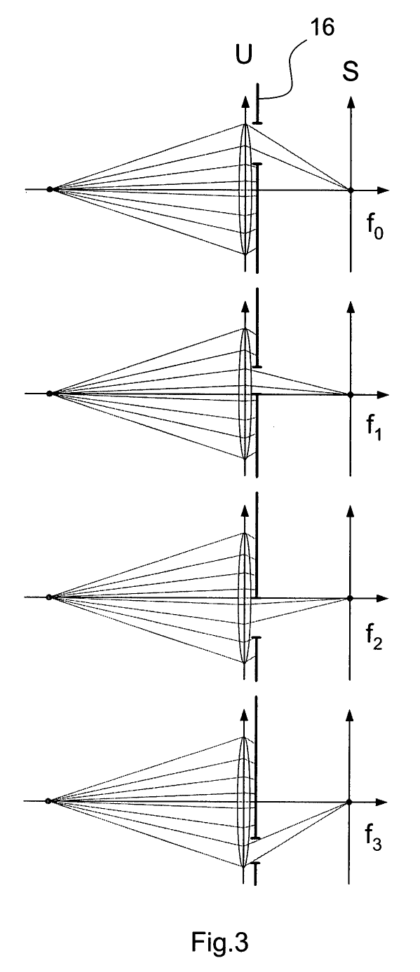

As shown in FIG. 3, the plane where the lens assembly is located is defined as a UV plane, and the imaging plane is defined as an ST plane. Because FIG. 3 is a longitudinal cross-sectional view, only the U-axis and S-axis can be seen. Subsequent description will also be in connection with these two axes. In this 1-D embodiment, the programmable aperture 16 is used to divide the lens assembly into 4 regions (in an actual 2-D lens, the lens assembly should be divided into 4×4 regions). A manner of opening a single region of the lens assembly each time is adopted to capture light rays from each region on the U plane to the S plane so as to acquire the complete light field.

In this manner, assuming the exposure time of each picture is T, a period of time 16T is required to take 16 pictures for putting the complete light field data in order. Exemplified with digital refocusing, an integration step after an image processing step is performed to these 16 pictures to acquire a picture with an exposure time of T.

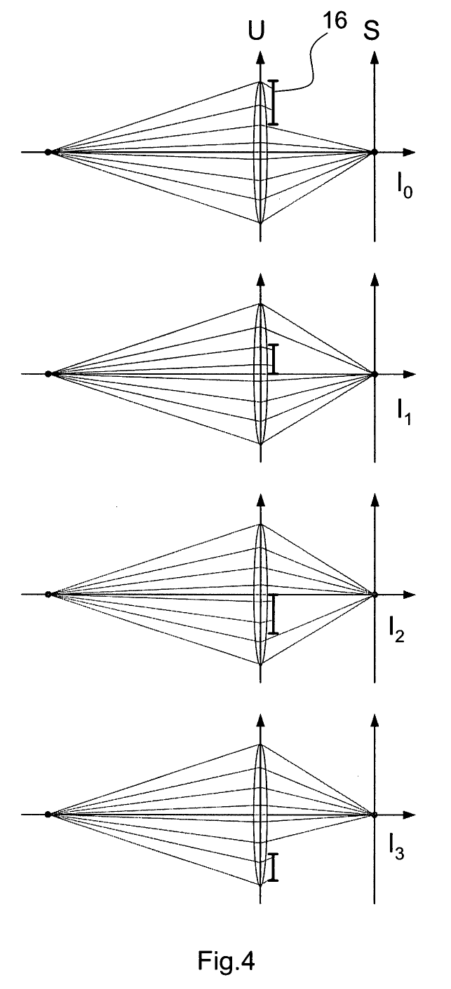

FIG. 4 is a diagram showing how the programmable aperture transmits or blocks light according to a second embodiment of the present invention. This embodiment differs from the above embodiment in that the programmable aperture 16 is used to close a region of the lens assembly each time. In this 1-D embodiment, 4 images I₀ to I₃ represented by the following four equations can be obtained:

I₀(s)=f(1,s)+f(2,s)+f(3,s)

I₁(s)=f(0,s)+f(2,s)+f(3,s)

I₂(s)=f(0,s)+f(1,s)+f(3,s)

I₃(s)−f(0,s)+f(1,s)+f(2,s)

By rearranging the above equations, the original light fields f(0,s) to f(3,s) can be restored:

$$[ \begin{matrix}{I}_{0} ( s ) \\ {I}_{1} ( s ) \\ {I}_{2} ( s ) \\ {I}_{3} ( s )\end{matrix} ] = [ \begin{matrix}0 & 1 & 1 & 1 \\ 1 & 0 & 1 & 1 \\ 1 & 1 & 0 & 1 \\ 1 & 1 & 1 & 0\end{matrix} ] [ \begin{matrix}f ( 0 , s ) \\ f ( 1 , s ) \\ f ( 2 , s ) \\ f ( 3 , s )\end{matrix} ] ⇒ [ \begin{matrix}f ( 0 , s ) \\ f ( 1 , s ) \\ f ( 2 , s ) \\ f ( 3 , s )\end{matrix} ] = {[ \begin{matrix}0 & 1 & 1 & 1 \\ 1 & 0 & 1 & 1 \\ 1 & 1 & 0 & 1 \\ 1 & 1 & 1 & 0\end{matrix} ]}^{- 1} [ \begin{matrix}{I}_{0} ( s ) \\ {I}_{1} ( s ) \\ {I}_{2} ( s ) \\ {I}_{3} ( s )\end{matrix} ]$$

By using this method, the same period of time 16T is required for taking 16 pictures. The light transmission time of each region on the lens assembly, however, is 15T. Therefore, the result generated by digital refocusing is equivalent to taking a picture with an exposure time of 15T using a conventional camera. This method can greatly reduce the time required for capturing the light field as compare to the first embodiment.

With regard to noise problems, the Hadamard matrix can be used to achieve higher signal-to-noise ratios.

The programmable aperture 16 can be realized with many different methods or materials. For instance, the programmable aperture 16 comprises a liquid crystal array, a patterned turntable, or a mechanical aperture, or comprises an aperture of an existent camera collocated with a programmable light transmitting or blocking element. The programmable light transmitting or blocking element comprises a liquid crystal array, a patterned turntable, or a mechanical light transmitting or blocking plate.

There are two ways of constructing the programmable aperture (or the programmable light transmitting or blocking element) using a patterned turntable or a liquid crystal array.

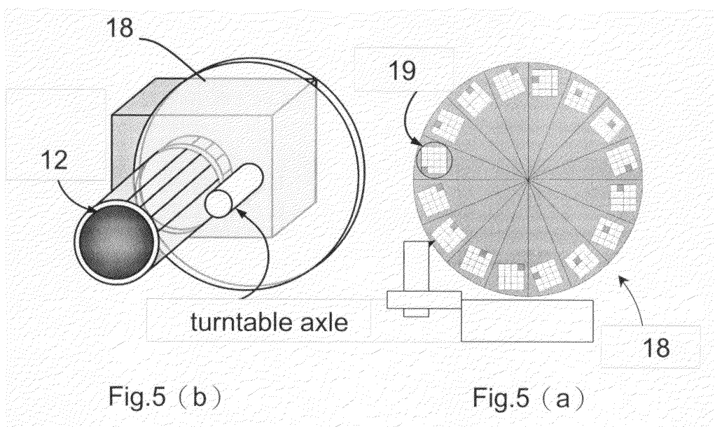

The first way is to arrange a patterned turntable 18 on a camera, as shown in FIG. 5(a). The patterned turntable 18 can be arranged at the position on the camera shown in FIG. 5(b), or can be arranged between the lens assembly 12 and the sensor array (not shown). The patterned turntable 18 has many different light transmitting patterns 19, on which white regions are parts that transmit light while black regions are parts that block light. Therefore, when the patterned turntable 18 turns to different positions, the light transmitting positions of the lens assembly change. The lens assembly of the present invention can thus be divided into different regions. By changing the position of the aperture on the lens assembly, several different sets of images can be obtained to acquire complete light field information.

The other way is to replace the above patterned turntable with a liquid crystal array. By applying voltages to change the light transmittance of liquid crystal, the required light transmitting patterns can be edited out.

In summary, the present invention provides a camera using a programmable aperture to perform highly concentrated capture of a light field. Under the situation that the total exposure is not affected, a programmable aperture having a plurality of regions is arranged behind the lens assembly. Partial portions of the plurality of regions are opened or closed in a programming way in order to change the shape of the aperture or the light transmittance of the lens assembly so that complete data of the light field can be captured when taking a picture. Therefore, users need not wait for auto-focus of the camera as usual. Moreover, users can restore the depth model of the photographed object after acquiring the light field data, and can then refocus after digital processing. Furthermore, as compared to conventional light field cameras, the present invention does not use any expensive optical elements such as the microlens array, but adopts a programmable aperture of lower cost and simpler manufacturing to achieve the same effect, hence greatly lowering the cost of the light field camera. In addition to capturing light field, the camera of the present invention still maintains the conventional operation of a common camera.

Although the present invention has been described with reference to the preferred embodiments thereof, it should be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A camera using a programmable aperture comprising:
a lens assembly;
at least one sensor located behind the lens assembly for capturing an image via the lens assembly; and
a programmable aperture located between the lens assembly and the sensor for dynamically adjusting aperture shape and light transmittance of the lens assembly when taking a picture, the programmable aperture comprising a plurality of regions, partial portions of the plurality of regions being opened or closed each time to allow the partial regions to selectively transmit or block light so as to obtain several different sets of images, the images being able to restore a complete light field.

2. The camera as claimed in claim 1, wherein the lens assembly is a lens.

3. The camera as claimed in claim 1, wherein the sensor is a sensor array.

4. The camera as claimed in claim 1, wherein the programmable aperture comprises an aperture and a light transmitting element, and the light transmitting element selectively allows partial regions to transmit light.

5. The camera as claimed in claim 4, wherein the light transmitting element transmits one region at a time.

6. The camera as claimed in claim 1, wherein the programmable aperture comprises an aperture and a light blocking element, and the light blocking element selectively blocks partial regions.

7. The camera as claimed in claim 6, wherein the light blocking element blocks one region at a time.

8. The camera as claimed in claim 1, wherein a superposition operation is performed to imaging signals received by sensor in order to acquire the complete light field.

9. The camera as claimed in claim 1, wherein the programmable aperture comprises a liquid crystal array, a patterned turntable, or a mechanical aperture.

10. The camera as claimed in claim 4, wherein the light transmitting element comprises a liquid crystal array, a patterned turntable, or a mechanical light transmitting plate.

11. The camera as claimed in claim 6, wherein the light transmitting element comprises a liquid crystal array, a patterned turntable, or a mechanical light blocking plate.

12. A camera with a programmable aperture comprising:
a lens assembly;
at least one sensor located behind the lens assembly for capturing an image via the lens assembly;
an aperture located between the lens assembly and the sensor for controlling light transmittance of the lens assembly; and
a programmable light transmitting or blocking element for dynamically adjusting aperture shape, the programmable light transmitting or blocking element comprising a plurality of regions, partial portions of the plurality of regions being opened or closed each time to let the partial regions selectively transmit or block light so as to obtain several different sets of images, the images being able to restore a complete light field.

13. The camera as claimed in claim 12, wherein the lens assembly is a lens.

14. The camera as claimed in claim 12, wherein the sensor is a sensor array.

15. The camera as claimed in claim 12, wherein the light transmitting or blocking element opens or closes one region each time.

16. The camera as claimed in claim 12, wherein a superposition operation is performed to imaging signals received by the sensor to acquire the complete light field.

17. The camera as claimed in claim 12, wherein the programmable light transmitting or blocking element comprises a liquid crystal array, a patterned turntable, or a mechanical light transmitting or blocking plate.
